(19) United States
(12) Patent Application Publication
(10) Pub. No.: US 2023/0380350 A1
(43) Pub. Date: Nov. 30, 2023

(54) Pot Attachment Device

(71) Applicant: Tyler Ousley, Seattle, WA (US)

(72) Inventor: Tyler Ousley, Seattle, WA (US)

(21) Appl. No.: 17/827,736

(22) Filed: May 29, 2022

(51) Int. Cl. A01G 9/02

(52) U.S. Cl. CPC A01G 9/02

(57) ABSTRACT

A pot attachment device for attaching a pot to a structure includes a flexible bag, into which a pot is insertable so that its upper end is positioned below the pot's top. A cord is woven into the flexible bag, proximate to the upper end, so that segments of the cord adjacent to its opposed ends extend from the flexible bag. The segments can be grasped in hands of a user to pull on the segments to cinch the upper end of the flexible bag around the pot and to position the cord around an element of a structure. Couplers, which are attached singly to the opposed ends of the cord, can selectively attach to either the cord or the flexible bag to secure the cord around the element of the structure. The pot thus is removably attached to the element of the structure.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to attachment devices and more particularly pertains to a new attachment device for attaching a pot to a structure. The present invention discloses an attachment device comprising a flexible bag, into which a pot is insertable, that can be attached to an element of a structure to removably attach the pot to the structure.

### (2) Description of Related Art Including Information Disclosed Under 37 CFR 1.97 and 1.98

The prior art relates to attachment devices. Related prior art comprises elongated and soil filled hangable flexible bags with side apertures for plants, mesh or cloth pots that are hangable, and pots comprised of fabric. The prior art does not teach an attachment device comprising a flexible bag, into which a pot is insertable, that can be attached to an element of a structure to removably attach the pot to the structure.

### BRIEF SUMMARY OF THE INVENTION

An embodiment of the disclosure meets the needs presented above by generally comprising a flexible bag, which is configured for insertion of a pot so that an upper end of the flexible bag is positioned below a top of the pot. A cord is woven into the flexible bag, proximate to the upper end, so that segments of the cord adjacent to opposed ends of the cord extend from the flexible bag. The segments are configured to be grasped in hands of a user, positioning the user to pull on the segments to cinch the upper end of the flexible bag around the pot and to position the cord around an element of a structure. The couplers of a pair of couplers are attached singly to the opposed ends of the cord. The couplers are configured to selectively attach to either the cord or the flexible bag to secure the cord around the element of the structure. The pot thus is removably attached to the element of the structure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a pot attachment device according to an embodiment of the disclosure.

FIG. 2 is a side view of an embodiment of the disclosure.

FIG. 3 is a front view of an embodiment of the disclosure.

FIG. 4 is a rear view of an embodiment of the disclosure.

FIG. 5 is a bottom view of an embodiment of the disclosure.

FIG. 6 is a flow diagram for a method utilizing an embodiment of the disclosure.

### DETAILED DESCRIPTION OF THE INVENTION

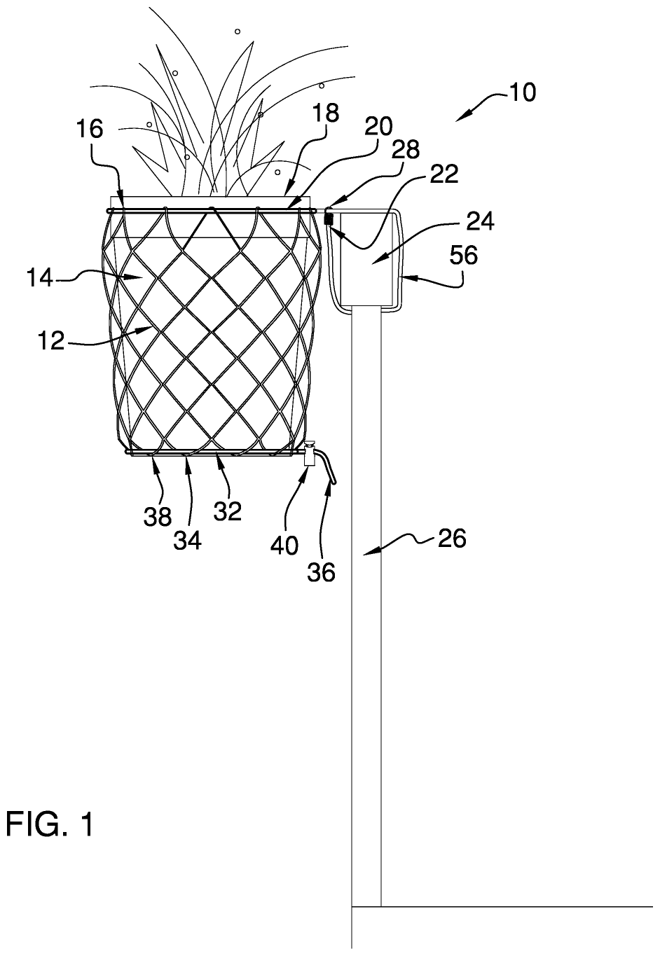

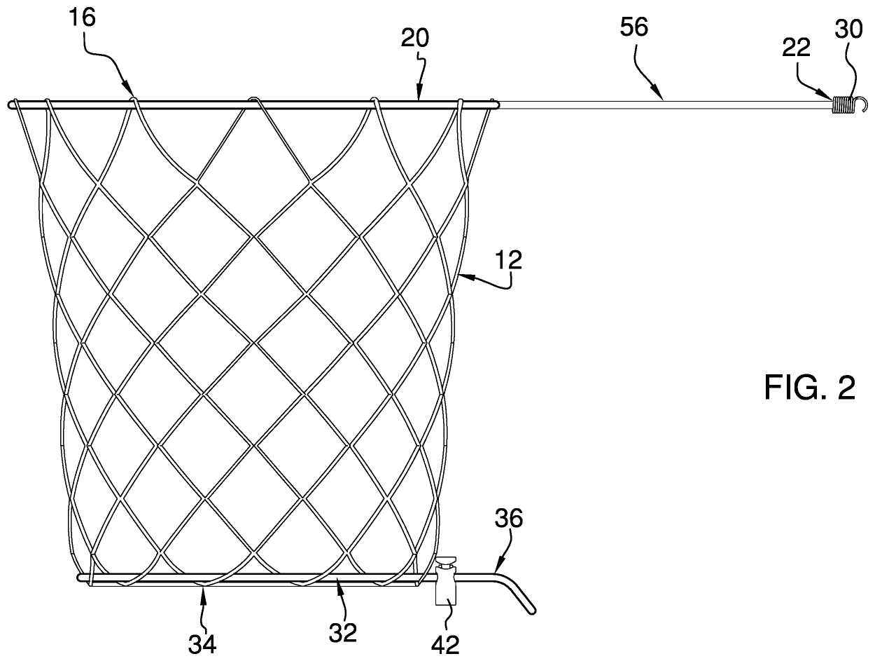

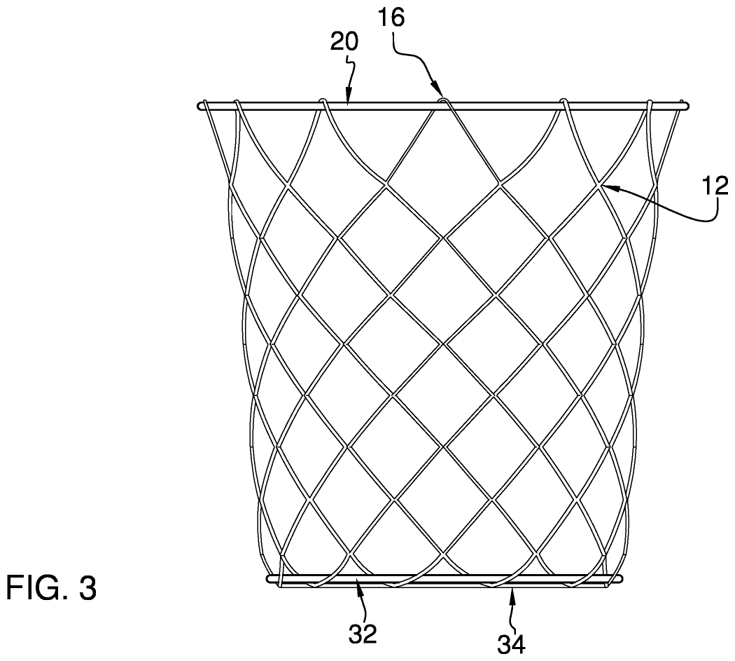

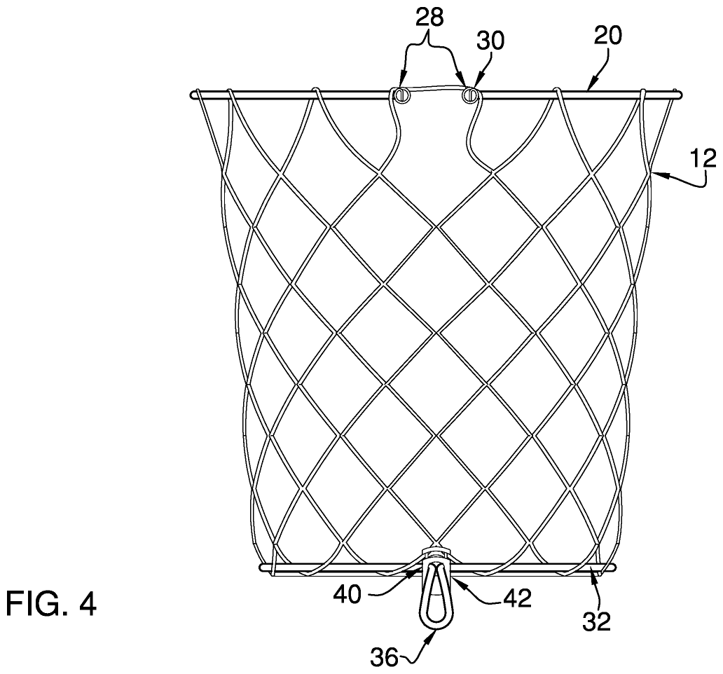

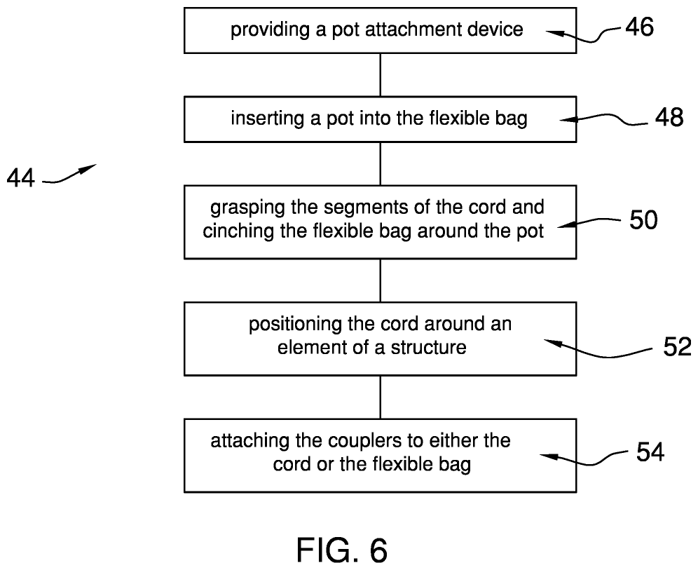

With reference now to the drawings, and in particular to FIGS. 1 through 6 thereof, a new attachment device embodying the principles and concepts of an embodiment of the disclosure and generally designated by the reference numeral 10 will be described.

As best illustrated in FIGS. 1 through 6, the pot attachment device 10 generally comprises a flexible bag 12, which is configured for insertion of a pot 14 so that an upper end 16 of the flexible bag 12 is positioned below a top 18 of the pot 14. The flexible bag 12 may comprise mesh, cloth, fabric, or the like. With the flexible pot 14 comprising mesh, it is substantially visible, whereas with cloth or fabric, the pot 14 is substantially shielded from view, which allows for repurposing of a pot 14 that is worn or otherwise unsightly.

A cord 20 is woven into the flexible bag 12, proximate to the upper end 16, so that segments 56 of the cord 20 adjacent to opposed ends 22 of the cord 20 extend from the flexible bag 12. The segments 56 are configured to be grasped in hands of a user, positioning the user to pull on the segments 56 to cinch the upper end 16 of the flexible bag 12 around the pot 14 and to position the cord 20 around an element 24 of a structure 26, such as a top rail of a railing, as shown in FIG. 1. The cord 20 may be resiliently stretchable.

The couplers 28 of a pair of couplers 28 are attached singly to the opposed ends 22 of the cord 20. Each coupler 28 comprise s a hook 30, as shown in FIG. 1, an eyelet, a piece of a hook and loop fastener, or the like. The couplers 28 are configured to selectively attach to either the cord 20 or the flexible bag 12 to secure the cord 20 around the element 24 of the structure 26. The pot 14 thus is removably attached to the element 24 of the structure 26.

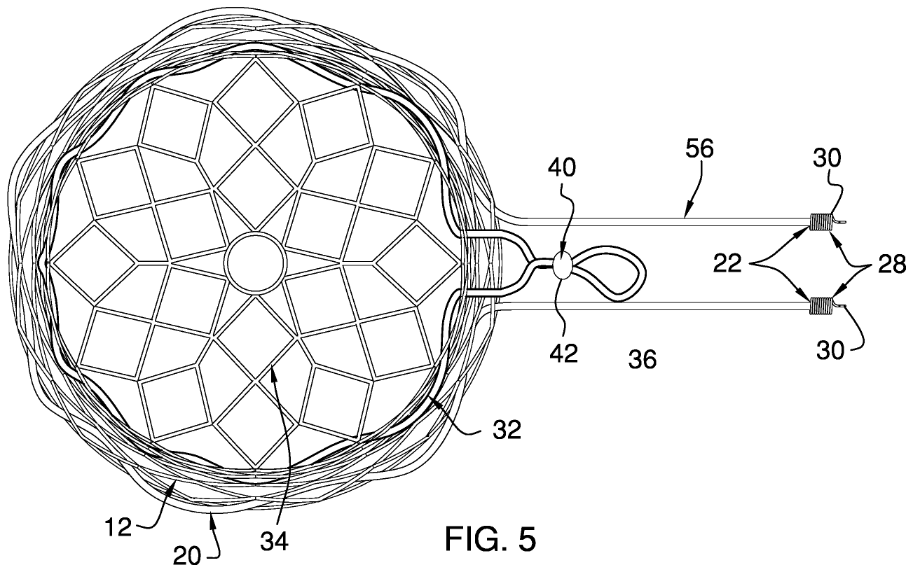

As shown in FIG. 5, an endless line 32 is woven into the flexible bag 12, proximate to a lower end 34 of the flexible bag 12. A section 36 of the endless line 32 extends from the flexible bag 12 and is configured to be grasped in a hand of a user. The user can pull on the section 36 to cinch the lower end 34 of the flexible bag 12 around the pot 14 proximate to a bottom 38 of the pot 14. A fastener 40 is slidably positioned on the section 36 of the endless line 32 and is configured to selectively attach to the endless line 32. Attachment of the fastener 40 to the endless line 32 fixedly positions the lower end 34 of the flexible bag 12 in a cinched configuration around the pot 14, thereby producing a tidier look. As shown in FIG. 5, the fastener 40 comprises a cord lock 42.

A variety of configurations of the pot attachment device 10 are anticipated by the present invention. For example, a fastener 40 may not be attached to the endless line 32, which could simply be cinched and then knotted. Configured as such, the pot attachment device 10 would be more difficult to repurpose. Additionally, the endless line 32 need not be endless, thus having opposed termini (not shown), for the pot attachment device 10 to function. Additional fasteners 40 could thus be incorporated at the opposed termini and could be used to further secure the pot 14 to the structure 26.

The present invention also anticipates use of a spacer (not shown), which would be positioned between the flexible bag 12 and the pot 14, proximate to the bottom 38 of the pot 14, should the pot 14 have a bottom 38 that is circumferentially smaller that its top 18. The spacer would level the top 18 of the pot 14 by resting against the structure 26.

In use, the pot attachment device 10 enables a method 44 of attaching a pot 14 to an element 24 of a structure 26. The method 44 comprises a first step 46 of providing a pot attachment device 10 according to the specification above. A second step 48 of the method 44 is inserting a pot 14 into the flexible bag 12. A third step 50 of the method 44 is grasping the segments 56 of the cord 20 and cinching the flexible bag 12 around the pot 14. A fourth step 52 of the method 44 is positioning the cord 20 around an element 24 of a structure 26. A fifth step 54 of the method 44 is attaching the couplers 28 to either the cord 20 or the flexible bag 12 to removably attach the pot 14 to the element 24 of the structure 26.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pot attachment device comprising:
a flexible bag configured for insertion of a pot, such that an upper end of the flexible bag is positioned below a top of the pot;
a cord woven into the flexible bag proximate to the upper end, such that segments of the cord adjacent to opposed ends of the cord extend from the flexible bag, wherein the segments are configured for grasping in hands of a user, positioning the user for pulling on the segments for cinching the upper end of the flexible bag around the pot and for positioning the cord around an element of a structure; and
a pair of couplers attached singly to the opposed ends of the cord and being configured for selectively attaching to either the cord or the flexible bag for securing the cord around the element of the structure, such that the pot is removably attached to the element of the structure.

2. The pot attachment device of claim 1, wherein the flexible bag comprises mesh, cloth, or fabric.

3. The pot attachment device of claim 1, wherein each coupler comprises a hook.

4. The pot attachment device of claim 1, further including:
an endless line woven into the flexible bag proximate to a lower end of the flexible bag, such that a section of the endless line extends from the flexible bag, wherein the section is configured for grasping in a hand of a user, positioning the user for pulling on the section for cinching the lower end of the flexible bag around the pot proximate to a bottom of the pot; and
a fastener slidably positioned on the section of the endless line and being configured for selectively attaching to the endless line for fixedly positioning the lower end of the flexible bag in a cinched configuration around the pot.

5. The pot attachment device of claim 4, wherein the fastener comprises a cord lock.

6. A method of attaching a pot to an element of a structure, the method comprising the steps of:
providing a pot attachment device comprising
a flexible bag configured for insertion of a pot, such that an upper end of the flexible bag is positioned below a top of the pot,
a cord woven into the flexible bag proximate to the upper end, such that segments of the cord adjacent to opposed ends of the cord extend from the flexible bag, wherein the segments are configured for grasping in hands of a user, positioning the user for pulling on the segments for cinching the upper end of the flexible bag around the pot and for positioning the cord around an element of a structure, and
a pair of couplers attached singly to the opposed ends of the cord and being configured for selectively attaching to either the cord or the flexible bag for securing the cord around the element of the structure, such that the pot is removably attached to the element of the structure;
inserting a pot into the flexible bag;
grasping the segments of the cord and cinching the flexible bag around the pot;
positioning the cord around an element of a structure; and
attaching the couplers to either the cord or the flexible bag to removably attach the pot to the element of the structure.

7. A pot attachment device comprising:
a flexible bag configured for insertion of a pot, such that an upper end of the flexible bag is positioned below a top of the pot, the flexible bag comprising mesh, cloth, or fabric;
a cord woven into the flexible bag proximate to the upper end, such that segments of the cord adjacent to opposed ends of the cord extend from the flexible bag, wherein the segments are configured for grasping in hands of a user, positioning the user for pulling on the segments for cinching the upper end of the flexible bag around the pot and for positioning the cord around an element of a structure;
a pair of couplers attached singly to the opposed ends of the cord and being configured for selectively attaching to either the cord or the flexible bag for securing the cord around the element of the structure, such that the pot is removably attached to the element of the structure, each coupler comprising a hook;
an endless line woven into the flexible bag proximate to a lower end of the flexible bag, such that a section of the endless line extends from the flexible bag, wherein the section is configured for grasping in a hand of a user, positioning the user for pulling on the section for cinching the lower end of the flexible bag around the pot proximate to a bottom of the pot; and
a fastener slidably positioned on the section of the endless line and being configured for selectively attaching to the endless line for fixedly positioning the lower end of the flexible bag in a cinched configuration around the pot, the fastener comprising a cord lock.
